(19) United States
(12) Patent Application Publication
(10) Pub. No.: US 2023/0376708 A1
(43) Pub. Date: Nov. 23, 2023

(54) SYSTEM AND METHOD FOR A SPECIMEN CONTAINER FOR USE IN CABINET X-RAY SYSTEMS

(71) Applicant: VIKRAM BUTANI, STRATFORD, CT (US)

(72) Inventors: VIKRAM BUTANI, STRATFORD, CT (US); CHESTER LOWE, PALM SPRINGS, CA (US)

(73) Assignee: KUB TECHNOLOGIES, INC. DBA KUBTEC, STRATFORD, CT (US)

(21) Appl. No.: 18/098,106

(22) Filed: Jan. 17, 2023

Related U.S. Application Data
(60) Provisional application No. 63/299,507, filed on Jan. 14, 2022.

(51) Int. Cl. G06K 7/10; G06K 19/077; H01Q 1/22

(52) U.S. Cl. CPC G06K 7/10405; G06K 19/07758; H01Q 1/2216

(57) ABSTRACT

The present invention relates to the requirements for specimen tracking and maintenance in a cabinet x-ray system incorporating an x-ray tube, an x-ray detector, and an optical camera for the production of blended images. Excised tissue specimens are amorphous and quickly loose anatomical registration at the margins. The current device provides for breast specimens for a variety of sizes to be maintained accurately while successive images are acquired. Additionally, the base of the unit contains an RFID tag which ensures proper identification of the sample. In particular, the invention relates to a system and method with corresponding apparatus for acquiring multiple images in succession while maintaining specimen geometry and ensuring the image information is correctly identified with the corresponding patient.

Currently it is believed that there is not a system or method incorporating specimen suspension to maintain the integrity of the excised tissue and RFID tracking for tissue specimen/sample imaging in a cabinet x-ray system.

### CROSS-REFERENCE TO RELATED APPLICATIONS

This application claims priority to and the benefit of U.S. Provisional Patent Application Ser. No. 63/299,507 filed Jan. 14, 2022, the disclosure of which is incorporated herein by reference in its entirety.

### BACKGROUND

### Field of the Present Disclosure

The present invention relates to the field of a cabinet x-ray incorporating a system and method for maintaining specimen traceability using radio frequency identification (RFID) tags, in a container with a lid that preserves specimen (excised tissue specimen) integrity while taking a series of tomographic x-ray images and optical images, for diagnostic evaluation of cancers and/or other abnormalities within the tissue as well as maintains the specimen shape In general, this enclosure may enable a device (cabinet x-ray system specimen container) to accommodate different sized tissue specimens to be contained in a way that preserves its original shape.

### Background

The present system would provide a means to place excised tissue into a unique device capable of maintaining the specimen in its original shape while taking both optical as well as a series of x-ray images at several positions such that a tomographic representation can be created which reflects the 3-dimensional volume of the tissue with greater accuracy versus the 3-dimensional aspect prior to removal from the patient.

It would be advantageous for a cabinet x-ray system to provide a means for the unique identification of specimens for traceability and to preserve specimen integrity during handling, transport, and tomographic imaging.

When employed, excised tissue specimens would be uniquely identified, in a closed system capable of preserving tissue integrity while a series of x-ray images were taken for tomographic reconstruction and be able to maintain the excised shape.

Currently it is believed that there is not a system or method incorporating such a feature in a cabinet x-ray system for the purposes of tomographic imaging.

### DESCRIPTION OF THE RELATED ART

In general, this disclosure may enable a device (cabinet x-ray system specimen container) to accommodate variously sized tissue specimens to be contained in a way that preserves its original shape while allowing for specimen tracking using a radio frequency identification tag.

A preferred embodiment system would incorporate a series of concentric holding with the following elements:
[symbol] To be Self-contained to hold the specimen after accession
[symbol] To have Adjustable spacing to hold the specimen in its shape
[symbol] To allow for the Specimen to be X-ray imaged inside the set-up without any compromise in the X-ray image output
[symbol] To allow for the Specimen to be Optical imaged inside the set-up without any compromise in the Optical image output
[symbol] To allow for the Specimen to be transported inside the container with the lid
[symbol] To ensure there shall be zero chemical interaction between container and the specimen
[symbol] To ensure each container shall have wireless unique identifiers which shall be linked with patient data and to make sure each container is used only with one specimen
[symbol] To ensure each container assembly shall be packed in individual pouches and packed in boxed in pre-determined quantities
[symbol] To ensure that the container and the assembly shall be clean of any dust or debris which could cause X-ray image contamination
[symbol] To ensure that each box shall be serialized for traceability

The present system would provide a means to place excised tissue into a unique device capable of maintaining the specimen in it's original shape while taking both optical as well as a series of x-ray images at several positions such that a tomographic representation can be created which reflects the 3 dimensional volume of the tissue with greater accuracy versus the 3 dimensional aspect prior to removal from the patient.

The embodiment as related above explains how this invention would relate to optical and radiography specimen handling for imaging and tracking.

### SUMMARY

The present invention relates to the field of a cabinet x-ray incorporating an x-ray tube, and an x-ray detector for the production specimen images. The specimen container uses a suspension system to maintain the specimen in a 3-dimensional configuration that most closely represents the specimen as it existed in the patient. The specimen can be covered and transported to the imaging system utilizing RFID tags to ensure tracking and assignment of data to the correct patient. Subsequently the specimen can be imaged both optically and radiographically using a tomographic approach to accurately represent the original 3-dimensional configuration of the specimen.

### BRIEF DESCRIPTION OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is one example embodiment of the present invention;

FIG. 2 is an example of the geometry and dimensions of the embodiment for pieces 1 through 5 of the present invention;

FIG. 3 is an example of the geometry and dimensions of the embodiment for pieces 6 through 8 of the present invention;

FIG. 4 is view in the of the geometry and dimensions of the embodiment of the present invention positioned within the imaging cabinet.

### DETAILED DESCRIPTION OF EMBODIMENT

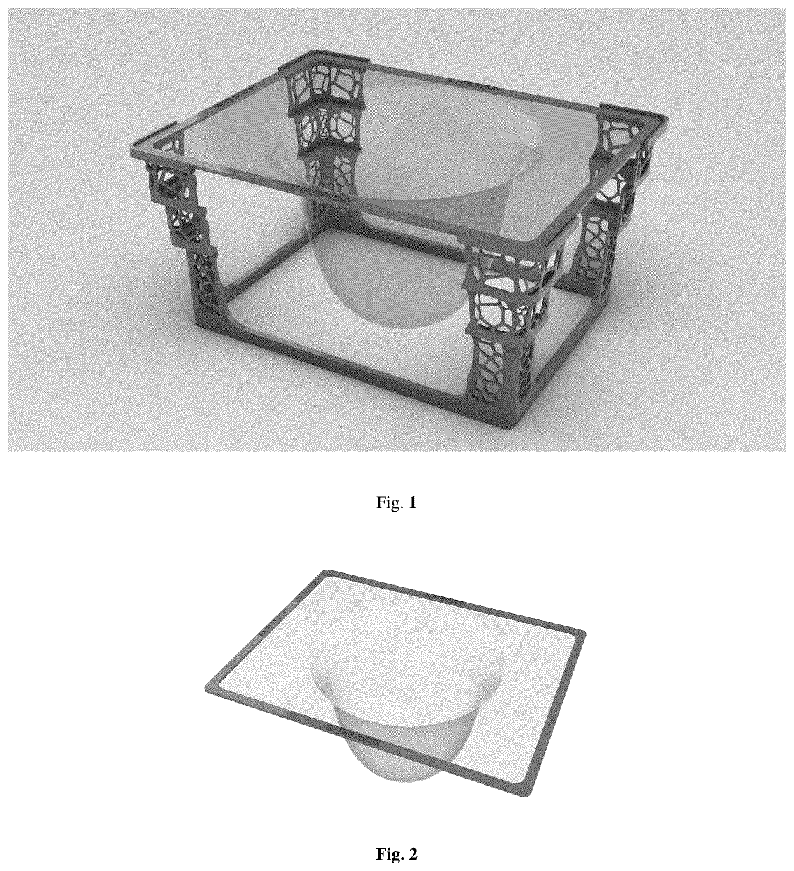

Reference will now be made to figures wherein like structures will be provided with like reference designations. It is understood that the drawings are diagrammatic and schematic representations of exemplary embodiments of the invention, and are not limiting of the present invention. FIGS. 1-4 depict various features of embodiments of the present invention, which embodiments are generally directed to a system that utilizes a container to correctly identify and maintain a specimen/sample in as close to its original geometry prior to excision as possible during the insertion and imaging in a cabinet x-ray system.

Referring first to FIG. 1, there is shown an example of the complete embodiment of a five progressively smaller sample enclosures contained within a box base that has an RFID tag for tracking, and a lid to preserve specimen integrity (1-8). The medical professional or other authorized operator places a specimen/sample into the appropriately resized container, by removing the smaller enclosures until the specimen/sample fits comfortably within the enclosure diameter. The operator then closes the lid and can identify the specimen/sample using the correspondingly activated RFID tag. Finally, the operator places the container with the specimen/sample into the x-ray imaging cabinet where successive x-ray and optical images can be acquired and blended for evaluation.

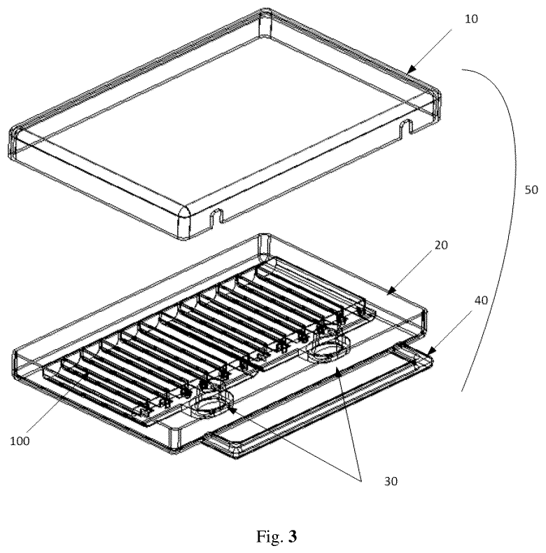

FIG. 2 presents the design for the container base (Piece 1) as well as the form inserts which provide for the 3.59″ (Piece 2), 4.50″ (Piece 3, 4×), 0.79: (Piece 4), and 1.72″ (Piece 5). The container is constructed of Polypropylene and is injection molded. The foam inserts are a cross linked polymer polyethylene foam designed to be non-absorbent (i.e. resistant to liquids) that will be machined to size. FIG. 3 displays the lid (Piece 6) as well as the 2.66″ diameter foam insert (Piece 7), and the RFID tag location on the base (Piece 8). The lid and foam insert are constructed out of the same materials descried in FIG. 2, and the RFID tag that is contactless and operates at a frequency of 860-960 MHz.

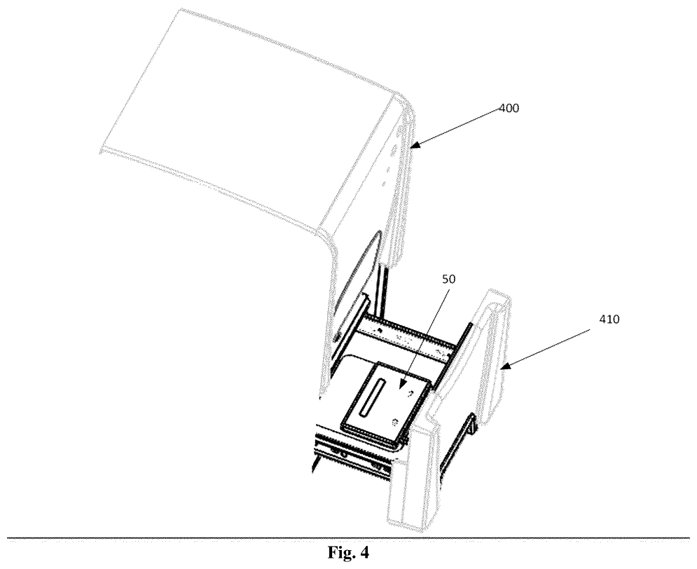

The placement location within the cabinet x-ray system is present in FIG. 4. The system is capable of generating multiple magnification levels by moving the container, with the specimen, progressively closer to the source of predetermined stage positions. In each case the RFID reader shall be capable of retrieving the information while the specimen container is within the cabinet.

Indeed, it is appreciated that the system and its individual components can include additional features and components, though not disclosed herein, while still preserving the principles of the present invention.

The present invention may be embodied in other specific forms without departing from its spirit or essential characteristics. The described embodiments are to be considered in all respects only as illustrative, not restrictive. All changes that come within the meaning and range of equivalency of the claims are to be embraced within their scope.

What is claimed is:

1. A specimen container system, comprising:
A. an enclosure base with an RFID tag;
B. a lid that covers the base;
C. device/apparatus will have 3 different reservoirs based on the volume of the specimen. They will be labeled as Large, medium, and small. These reservoirs can be placed on the predetermined location on the frame/skeleton provided. Small reservoir to be placed on lowest rung of the frame, medium on the middle rung and large on the topmost rung of the frame.
D. airtight plastic box for transport and storage.

2. The method and system as defined in claim 1, in which the specimen is maintained to capture an optical image;

3. The method and system as defined in claim 1, in which the specimen is maintained to capture an x-ray image;

4. The method and system of claim 1 to blend optical and x-ray images of tissue specimens generated while the sample is maintained in the specimen container;

5. The method and system of claim 1, in which the cabinet x-ray system utilizes an RFID tag to record and report patient information

6. The method and system of claim 1, in which the cabinet x-ray system utilizes an RFID reader to record and report patient information

7. The method and system of claim 1, in which manufactured from plastic

8. The method and system of claim 1, in which the reservoirs are clear plastic
